(19) United States
(12) Patent Application Publication
(10) Pub. No.: US 2026/0003832 A1
(43) Pub. Date: Jan. 1, 2026

(54) A PROVISIONING GATEWAY SYSTEM AND METHOD THEREOF

(71) Applicant: JIO PLATFORMS LIMITED, Ahmedabad (IN)

(72) Inventors: Mukta SHETTY, Thane (IN); Sayali Bhaskar JADHAV, Nashik (IN); Apoorva KHAMESRA, Udaipur (IN); Gaurav NARAYAN, Ranchi (IN); Aayush BHATNAGAR, Navi Mumbai (IN)

(73) Assignee: JIO PLATFORMS LIMITED, Ahmedabad (IN)

(21) Appl. No.: 18/992,371

(22) PCT Filed: Dec. 27, 2023
(86) PCT No.: PCT/IB2023/063274

§ 371 Date: Jan. 8, 2025

(30) Foreign Application Priority Data
Dec. 30, 2022 (IN) 202221077297

(51) Int. Cl. G06F 16/21; G06F 11/07

(52) U.S. Cl. CPC G06F 16/21; G06F 11/0721; G06F 11/0769

(57) ABSTRACT

The present disclosure relates to a provisioning gateway (108) that has the ability to forward provisioning requests to multiple network domains (106). This allows for greater efficiency and flexibility. This application is lightweight and it does not take up much hardware resources. The provisioning gateway (108) may forward the provisioning request(s) to a particular database (208) based on request message details on a RESTful interface. This single application acts as a gateway to forward request(s) to different destinations. By doing so, it provides a better user experience.

### RESERVATION OF RIGHTS

A portion of the disclosure of this patent document contains material which is subject to intellectual property rights such as, but are not limited to, copyright, design, trademark, integrated circuit (IC) layout design, and/or trade dress protection, belonging to Jio Platforms Limited (JPL) or its affiliates (herein after referred as owner). The owner has no objection to the facsimile reproduction by anyone of the patent document or the patent disclosure, as it appears in the Patent and Trademark Office patent files or records, but otherwise reserves all rights whatsoever. All rights to such intellectual property are fully reserved by the owner.

### FIELD OF INVENTION

The present disclosure relates generally to provisioning in telecommunications network. In particular, the present disclosure relates to a provisioning gateway for subscriber provisioning in the telecommunications network.

### BACKGROUND OF INVENTION

The following description of related art is intended to provide background information pertaining to the field of the disclosure. This section may include certain aspects of the art that may be related to various features of the present disclosure. However, it should be appreciated that this section be used only to enhance the understanding of the reader with respect to the present disclosure, and not as admissions of prior art.

Subscriber provisioning is important in every telecommunication domain, including the network, customer management, and billing. Customer experience and reducing customer churn is directly impacted by provisioning. To ensure a quality customer experience, telecommunication providers must have a robust provisioning infrastructure in place.

The existing subscriber provisioning solutions are time-consuming, have chances of data loss and/or data mismatch, and may lead to potential errors.

Therefore, there is a well-established need for an improved and efficient provisioning infrastructure that addresses at least the above-mentioned issues and shortcomings.

### OBJECTS OF THE INVENTION

An object of the present disclosure is to provide a robust provisioning infrastructure that improves customer experience and reduces customer churn.

An object of the present disclosure is to improve efficiency and flexibility by providing a provisioning gateway that may forward provisioning requests to multiple network domains.

An object of the present disclosure is to provide a single application to act as a provisioning gateway and forwarding requests to different destinations.

### SUMMARY

In an aspect, the present disclosure relates to a provisioning system, including one or more processors, and a memory operatively coupled with the one or more processors, wherein the memory includes processor-executable instructions which, when executed, cause the one or more processors to receive a provisioning request corresponding to a computing device via a provisioning node, determine one or more databases associated with the computing device based on the received provisioning request, multicast the provisioning request to provision a user associated with the computing device to the determined one or more databases, receive a response from the one or more databases based on provisioning identified in the provisioning request, and transmit the response to the provisioning node.

In an embodiment, the one or more processors may multicast the provisioning request to the one or more databases via an intermediary node.

In an embodiment, the response may include one of: a success response, a partial success response, and a failure response.

In an embodiment, in case of the failure response, the one or more processors may retransmit the provisioning request to at least one of: another provisioning system on a redundant site via the provisioning node; and another database of the one or more databases.

In an embodiment, the one or more processors may receive an error notification from the intermediary node, determine if the error notification corresponds to a pre-defined error list, in response to the error notification corresponding to the pre-defined error list, retransmit the provisioning request to the one or more databases through another intermediary node, and in response to the error notification not corresponding to the pre-defined error list, redirect the error notification to the provisioning node.

In an embodiment, the provisioning request may include at least one of: a transaction identifier (ID), an order ID, uniform resource locator (URL) associated with a service selected by the user of the computing device, file name, and file location.

In an embodiment, the one or more processors may multicast the provisioning request to the one or more databases over a RESTful interface.

In an embodiment, the one or more databases may include information about the user associated with the computing device served by a particular network domain.

In an embodiment, the network domain may include at least one of: 4G network domain, and 5G network domain.

In an embodiment, the one or more databases may include at least one of: 4G mobility database, 4G Internet of Things (IoT) database, 5G mobility database, and 5G IoT database.

In another aspect, the present disclosure relates to a method for provisioning requests, including receiving, by a provisioning system, a provisioning request corresponding to a computing device via a provisioning node, determining, by the provisioning system, one or more databases associated with the computing device based on the received provisioning request, multicasting, by the provisioning system, the provisioning request to provision a user associated with the computing device to the determined one or more databases, receiving, by the provisioning system, a response from the one or more databases based on provisioning identified in the provisioning request, and transmitting, by the provisioning system, the response to the provisioning node.

In an embodiment, the multicasting may include multicasting, by the provisioning system, the provisioning request to the one or more databases via an intermediary node.

In an embodiment, the response may include one of: a success response, a partial success response, and a failure response.

In an embodiment, in case of the failure response, the method may include retransmitting, by the provisioning system, the provisioning request to at least one of another provisioning system on a redundant site via the provisioning node, and another database of the one or more databases.

In an embodiment, the method may include receiving, by the provisioning system, an error notification from the intermediary node, determining, by the provisioning system, if the error notification corresponds to a pre-defined error list, in response to the error notification corresponding to the pre-defined error list, retransmitting, by the provisioning system, the provisioning request to the one or more databases through another intermediary node, and in response to the error notification not corresponding to the pre-defined error list, redirecting, by the provisioning system, the error notification to the provisioning node.

In another aspect, the present disclosure relates to a non-transitory computer-readable medium including processor-executable instructions that cause a processor to perform the methods discussed herein.

### BRIEF DESCRIPTION OF DRAWINGS

The accompanying drawings, which are incorporated herein, and constitute a part of this invention, illustrate exemplary embodiments of the disclosed methods and systems in which like reference numerals refer to the same parts throughout the different drawings. Components in the drawings are not necessarily to scale, emphasis instead being placed upon clearly illustrating the principles of the present invention. Some drawings may indicate the components using block diagrams and may not represent the internal circuitry of each component. It will be appreciated by those skilled in the art that invention of such drawings includes the invention of electrical components, electronic components or circuitry commonly used to implement such components.

FIG. 1 illustrates an exemplary system architecture for provisioning requests by a proposed system, in accordance with embodiments of the present disclosure.

FIGS. 2A-2B illustrate exemplary network architecture for implementing a provisioning gateway, in accordance with embodiments of the present disclosure.

FIGS. 3A-3B illustrate exemplary architecture for implementing a provisioning node, in accordance with embodiments of the present disclosure.

FIG. 4 illustrates an exemplary sequence diagram of a method for provisioning requests, in accordance with embodiments of the present disclosure.

FIG. 5 illustrates an exemplary computer system in which or with which embodiments of the present disclosure may be implemented.

The foregoing shall be more apparent from the following more detailed description of the disclosure.

### DETAILED DESCRIPTION OF INVENTION

In the following description, for the purposes of explanation, various specific details are set forth in order to provide a thorough understanding of embodiments of the present disclosure. It will be apparent, however, that embodiments of the present disclosure may be practiced without these specific details. Several features described hereafter can each be used independently of one another or with any combination of other features. An individual feature may not address all of the problems discussed above or might address only some of the problems discussed above. Some of the problems discussed above might not be fully addressed by any of the features described herein.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the invention as set forth.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive—in a manner similar to the term “comprising” as an open transition word—without precluding any additional or other elements.

Reference throughout this specification to “one embodiment” or “an embodiment” or “an instance” or “one instance” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

The present disclosure relates to systems and methods for provisioning subscriber requests in a telecommunications network. Subscriber information needs to be provisioned in multiple databases. This ensures that the subscriber can access all the features of a service. In addition, this also provides redundancy in case one database goes down. Further, customer experience and customer churn are directly impacted by provisioning. In order to ensure a quality customer experience, telecommunication service providers must ensure or implement a robust provisioning infrastructure. For example, multiple telecommunication service providers provision same subscriber information in different databases, as service providers need to deploy different core networks based on services and allocated spectrum.

Certain terms and phrases have been used throughout the disclosure and will have the following meanings in the context of the ongoing disclosure.

The term “Representational State Transfer (REST)” may refer to an architectural style that defines a set of constraints used for web services. A RESTful application program interface (API) may refer to an architectural style for an API that uses HTTP requests to access and use data.

The term “multicast” may refer to a group communication where data transmission is addressed to a group of destinations simultaneously. Multicast may be one-to-many or many-to-many distribution.

The term “NorthBound (NB) interface” may refer to an API or protocol that allows a lower-level network component to communicate with a higher-level or more central component.

The term “Internet of Things” may refer to a computing environment in which physical objects are embedded with devices which enable the physical objects to achieve greater value and service by exchanging data with other systems and/or other connected devices. Each physical object is uniquely identifiable through its embedded device(s) and is able to interoperate within an Internet infrastructure. The acronym “IoT,” as used herein, means “Internet of Things.”

The term File Transfer Protocol (FTP) may refer to a standard communication protocol used for the transfer of files from a server to a client on a network.

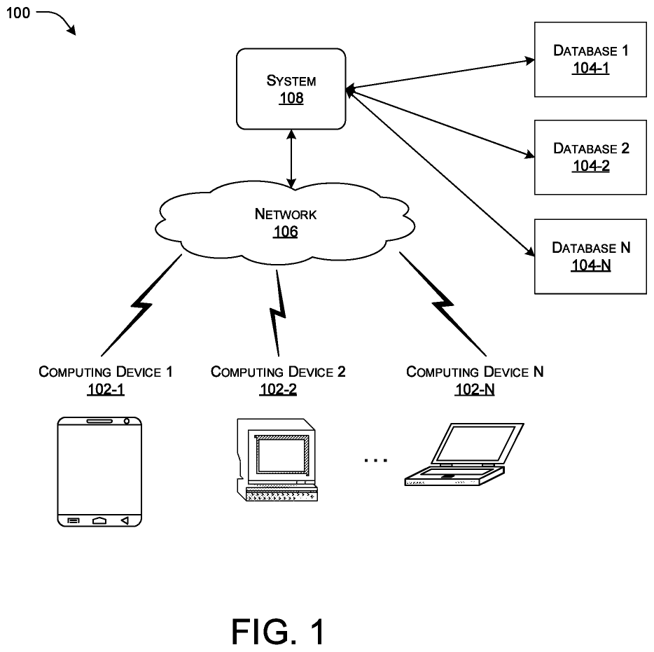

The various embodiments throughout the disclosure will be explained in more detail with reference to FIGS. 1-5.

Referring to FIG. 1, the present disclosure encompasses an exemplary system architecture 100 for provisioning subscriber information associated with requests. The system architecture 100 may comprise one or more computing devices (102-1, 102-2 . . . 102-N), one or more databases (104-1, 104-2 . . . 104-N), and a system such as a provisioning system 108. A person skilled in the art will understand that the one or more computing devices (102-1, 102-2 . . . 102-N) may be collectively referred as computing devices 102 and individually referred as computing device 102. The computing device 102 may be referred as a user equipment (UE), and the terms “computing device” and “user equipment (UE)” may be used interchangeably throughout the disclosure. Similarly, a person skilled in the art will understand that the one or more databases (104-1, 104-2 . . . 104-N) may be collectively referred as databases 104 and individually referred as database 104.

In an embodiment, the computing device 102 may include, but are not limited to, a handheld wireless communication device (e.g., a mobile phone, a smart phone, a phablet device, and so on), a wearable computer device (e.g., a head-mounted display computer device, a head-mounted camera device, a wristwatch computer device, and so on), a Global Positioning System (GPS) device, a laptop computer, a tablet computer, or another type of portable computer, a media playing device, a portable gaming system, and/or any other type of computer device with wireless communication capabilities, and the like. In an embodiment, the computing devices 102 may communicate with the provisioning system 108 via set of executable instructions residing on any operating system. In an embodiment, the computing devices 102 may include, but are not limited to, any electrical, electronic, electro-mechanical or an equipment or a combination of one or more of the above devices such as virtual reality (VR) devices, augmented reality (AR) devices, laptop, a general-purpose computer, desktop, personal digital assistant, tablet computer, mainframe computer, or any other computing device, wherein the computing device may include one or more in-built or externally coupled accessories including, but not limited to, a visual aid device such as camera, audio aid, a microphone, a keyboard, input devices for receiving input from a user such as touch pad, touch enabled screen, electronic pen and the like.

It may be appreciated that the computing devices 102 may not be restricted to the mentioned devices and various other devices may be used.

Referring to FIG. 1, the system architecture 100 may comprise a network 106 for establishing a communication between the computing device 102 and system 108. In an embodiment, the computing devices 102 may avail voice and data services using the network 106.

In an embodiment, the provisioning system 108 may encompass a provisioning gateway that has the ability to forward provisioning requests to multiple network domains 106 including, but not limited to, 4G and 5G (both mobility and Internet of Things (IoT)). This allows for greater efficiency and flexibility. In an embodiment, the provisioning system 108 may forward the provisioning requests to a particular database 104 based on details of the provisioning requests. In an embodiment, the provisioning system 108 may forward the provisioning requests to the database 104 over a RESTful interface. A person skilled in the art will understand that a Representational State Transfer (REST) is an architectural style that defines a set of constraints used for web services. A RESTful application program interface (API) is an architectural style for an API that uses HTTP requests to access and use data.

In an embodiment, each database 104 may be associated with a respective computing device 102. For example, the database 104-1 may store information related to the computing device 102-1. The database 104 may essentially store information about each subscriber (for example, the computing devices 102) served by a particular network domain 106. In an embodiment, the information associated with any particular subscriber is typically maintained in a record referred to as a “subscriber profile repository (SPR).” In an embodiment, the SPR may be each of the database 104.

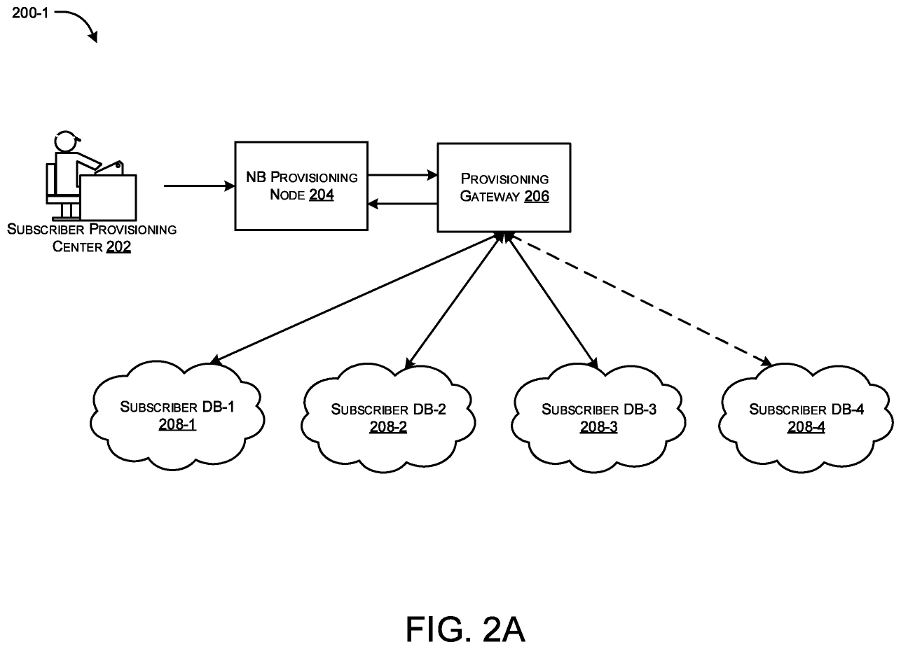

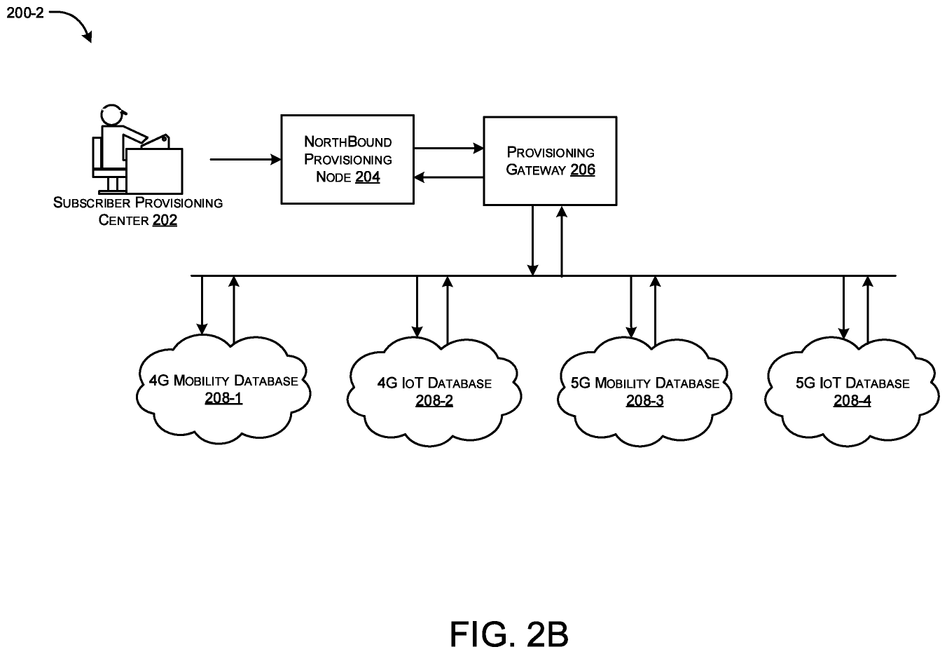

In an embodiment, the features subscribed to by a cellular subscriber, such as caller identification or call forwarding, are stored at a central server (not shown) associated with the computing device 102, and also stored in the database 104 associated with a service arca in which the computing device 104 is currently located, as discussed above. Thus, in order to provide a computing device 102 with enhanced service features, the profile in the database 104/SPR must be provisioned to associate those features with the computing device 102. Typically, the database 104 or the SPR is provisioned by an administrator or an employee of a wireless service provider or a subscriber provisioning center via a terminal device coupled to the database 104, which is further explained in detail with reference to FIGS. 2A and 2B.

In an embodiment, the system 108 may include a processor and a memory operatively coupled to the processor such that the memory may include processor-executable instructions which, when executed by the processor, cause the processor to perform the methods discussed herein. In some embodiments, a non-transitory computer-readable medium may include processor-executable instructions that cause the processor to perform the methods discussed herein.

Although FIG. 1 shows exemplary components of the system architecture 100, in other embodiments, the system architecture 100 may include fewer components, different components, differently arranged components, or additional functional components than depicted in FIG. 1. Additionally, or alternatively, one or more components of the system architecture 100 may perform functions described as being performed by one or more other components of the system architecture 100.

FIGS. 2A-2B illustrate exemplary network architecture (200-1, 200-2) for implementing a provisioning gateway, in accordance with embodiments of the present disclosure.

Referring to FIG. 2A, the network architecture 200-1 may comprise a subscriber provisioning center 202, a NorthBound (NB) provisioning node 204, a provisioning gateway 206, and one or more subscriber databases (208-1, 208-2, 208-3 . . . 208-N). A person skilled in the art will appreciate that the provisioning gateway 206 may be implemented as the provisioning system 108 of FIG. 1. Further, a person skilled in the art will appreciate that the one or more subscriber databases (208-1, 208-2, 208-3 . . . 208-N) may be similar to the one or more databases (104-1, 104-2 . . . 104-N) of FIG. 1 in their functionality.

Referring to FIG. 2A, the subscriber provisioning center 202 may be associated with a wireless telecommunication service provider. An employee or an administrator at the subscriber provisioning center 202 may provision subscriber information via a terminal device (not shown). In an embodiment, the terminal device may be similar to the computing device 102 of FIG. 1 in its functionality.

In an embodiment, the provisioning gateway 206 has the ability to multicast single request(s) to different subscriber databases (208-1, 208-2, 208-3 . . . 208-N). A person skilled in the art will understand that the one or more databases (208-1, 208-2, 208-3 . . . 208-N) may be collectively referred as databases 208 and individually referred as database 208. In an embodiment, the ability of the provisioning gateway 206 to multicast a single request to multiple databases 208 allows for faster database operations including, but not limited to, create, modify, get, delete, and the like. A person skilled in the art will understand that multicast is group communication where data transmission is addressed to a group of destinations simultaneously. Multicast may be one-to-many or many-to-many distribution.

Further, the provisioning gateway 206 ensures that the chance of data loss and/or data mismatch between the databases 208 is reduced by using an error handling capability, which is explained in detail herein.

Referring to FIG. 2A, the provisioning gateway 206 may receive provisioning request(s) from the NB provisioning node 204. In an embodiment, the provisioning gateway 206 may receive the provisioning request(s) from the NB provisioning node on REST API/interface. A person skilled in the art will understand that NorthBound (NB) interface is an API or protocol that allows a lower-level network component to communicate with a higher-level or more central component.

The provisioning gateway 206 may then multicast the provisioning request(s) to different databases 208 as per configuration requirements. In response to receiving a successful response from any of the databases 208, the provisioning gateway 206 may send a successful response to the NB provisioning node 204.

In an example embodiment, a user associated with a computing device such as the computing device 102 of FIG. 1 may request for activating service features such as, but not limited to, caller identification. The subscriber provisioning center 202 (for example, the wireless telecommunication service provider serving the computing device 102) may receive this request through an interface (not shown), and may generate a single provisioning request corresponding to the received request. The subscriber provisioning center 202 or the administrator at the subscriber provisioning center 202 may send the generated provisioning request to the provisioning gateway 206 via the NB provisioning node 204. In an embodiment, the provisioning gateway 206 may determine one or more appropriate databases 208 associated with the computing device 102 (or, the subscriber). For example, but not limited to, the provisioning gateway 206 may determine the appropriate databases 208 based on the provisioning request. Further, the provisioning gateway 206 may multicast the provisioning request to the determined databases 208 via the RESTful interface. The one or more databases 208 may then carry out provisioning identified in the provisioning request. In an embodiment, the one or more databases 208 may then generate and send a response to the provisioning gateway 206. The provisioning gateway 206 may send the successful response to the NB provisioning node 204. In an embodiment, a successful response may be sent to the user/subscriber associated with the computing device 102.

Referring to FIG. 2B, the network architecture 200-2 may include the one or more databases including, but not limited to, 4G mobility database 208-1, 4G IoT database 208-2, 5G mobility database 208-3, and 5G IoT database 208-4. In an embodiment, multiple provisioning gateway application processes may be instantiated on a same physical server, which can be used for IoT and mobility Policy and Charging Rules (PCRF)/Policy Control Function (PCF) subscriber provisioning. Both the running processes may support parallel provisioning of IoT and mobility PCRF/PCF subscribers without impacting each other. In an embodiment, both provisioning gateway application processes may have separate configuration and process identification (PID) on the same physical server.

It may be appreciated that the network architectures (200-1, 200-2) may be modular and flexible to accommodate any kind of changes in the architecture (200-1, 200-2).

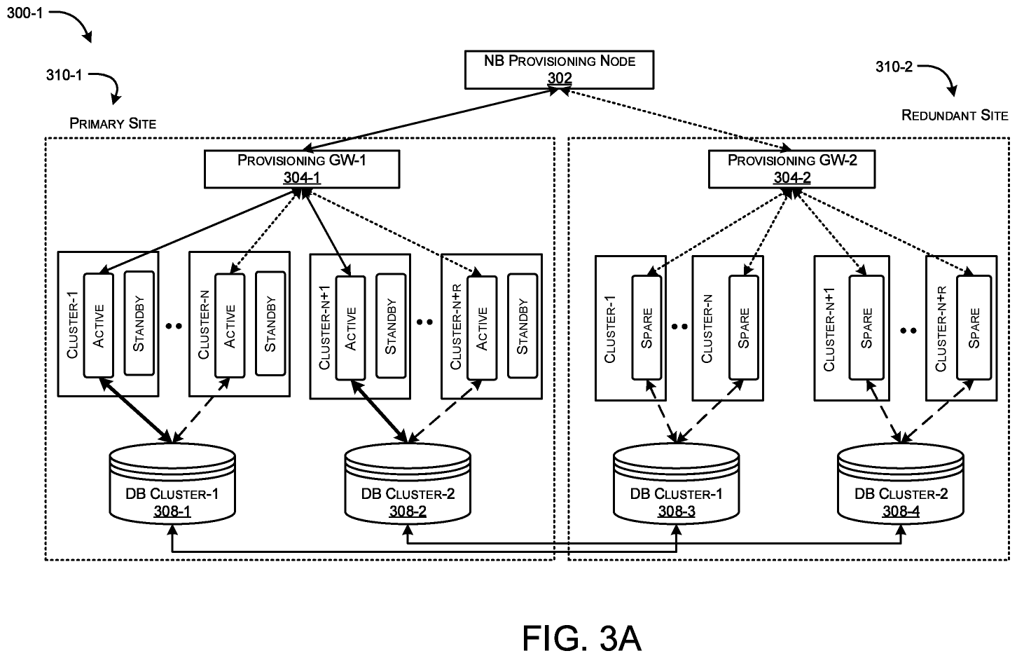

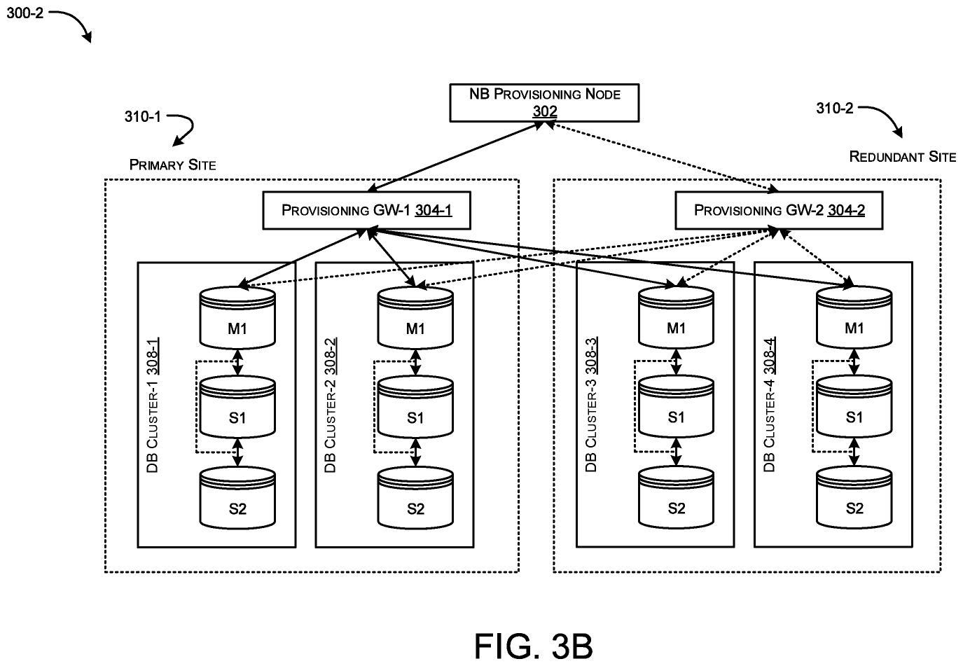

FIGS. 3A-3B illustrate exemplary architectures (300-1, 300-2) for implementing a provisioning node/gateway, in accordance with embodiments of the present disclosure.

Referring to FIG. 3A, the architecture 300-1 may comprise an NB provisioning node 302, a provisioning gateway 304-1 at a primary site 310-1, and a provisioning gateway 304-2 at a redundant site 310-2. A person skilled in the art will appreciate that the provisioning gateways (304-1, 304-2) may be similar to the provisioning gateway 206 of FIGS. 2A-2B in functionality, and hence, may not be described in detail again for the sake of brevity. Further, the NB provisioning node 302 may be similar to the NB provisioning node 204 of FIGS. 2A-2B in functionality, and hence, may not be described in detail again for the sake of brevity.

Referring to FIG. 3A, there is no direct communication between the provisioning gateway 304-1 at the primary site 310-1 and the provisioning gateway 304-2 at the redundant site 310-2. Further, the architecture 300-1 may comprise intermediate nodes associated with specific clusters, for example, at the primary site 310-1, clusters (1 . . . N, N+1, N+R) including active and standby storage spaces, and at the redundant site 310-2, clusters (1 . . . N, N+1, N+R) including spare storage spaces. Each of the clusters may be associated with one or more databases (308-1, 308-2, 308-3, 308-4). A person skilled in the art will understand that the one or more databases (308-1, 308-2, 308-3, 308-4) may be similar to the one or more databases (208-1, 208-2, 208-3, 208-4) of FIGS. 2A-2B and the one or more databases (104-1, 104-2 . . . 104-N) of FIG. 1 in functionality, and hence, may not be described in detail again for the sake of brevity.

In an embodiment, the database 308-1 may be similar to or may store similar information as of the database 308-3. Similarly, the database 308-2 may be similar to or may store similar information as of the database 308-4.

Referring to FIG. 3A, the NB provisioning node 302 may send provisioning request(s) to the provisioning gateways (304-1, 304-2), which may then multicast it to the databases 308 through the intermediary nodes. In an embodiment, if the provisioning gateway (304-1, 304-2) receives an error from any intermediate node (placed between the provisioning gateway (304-1, 304-2) and the databases 308) and that error belongs to a pre-defined error list, then the provisioning gateway (304-1, 304-2) may retry the request to another intermediate node of that database 308. For example, but not limited to, if the provisioning gateway 304-1 receives an error from an intermediary node associated with cluster 1, then the provisioning gateway 304-1 may retry the request to an intermediary node associated with cluster N, where both the cluster 1 and cluster N are associated with the database 308-1.

In an embodiment, the provisioning gateway (304-1, 304-2) may send request to one instance based on priority configuration. Priority configuration (group of instance Internet Protocol (IP)/fully qualified domain name (FQDN)) is for one cluster. In an embodiment, the priority is configurable and dependent on user. If the error code received from an intermediate node is different from the ones stored in the pre-defined error list, for example, success and custom error codes, then the provisioning gateway (304-1, 304-2) may redirect the response to the NB provisioning node 302. For example, but not limited to, if the NB provisioning node 302 receives the negative response from the provisioning gateway 304-1, then the NB provisioning node 302 may transmit the provisioning request(s) to the provisioning gateway 304-2 at the redundant site 310-2 for provisioning subscriber information at one of the spare database clusters. This process helps to identify and fix the errors that could otherwise lead to data loss. In doing so, the disclosed mechanism avoids potential disaster and keeps the subscriber data in-sync.

Referring to FIG. 3B, the architecture 300-2 depicts direct interaction of the provisioning gateways (304-1, 304-2) to the databases (308-1, 308-2, 308-3, 308-4). In an embodiment, the provisioning gateways (304-1, 304-2) support automatic retry mechanism. In case of connectivity failure/timeout, the provisioning gateways (304-1, 304-2) may buffer the entries so that once connectivity is restored, the provisioning gateways (304-1, 304-2) may use the buffer for writing the missed entries to the databases 308. In an embodiment, the provisioning gateways (304-1, 304-2) may support fault and alarm management functionality for operational case. Counters and alarms may be separated based on the network domain, for example, 4G mobility, 5G mobility, 4G IoT, and 5G IoT cellular technology.

It may be appreciated that the architectures (300-1, 300-2) may be modular and flexible to accommodate any kind of changes in the architecture (300-1, 300-2).

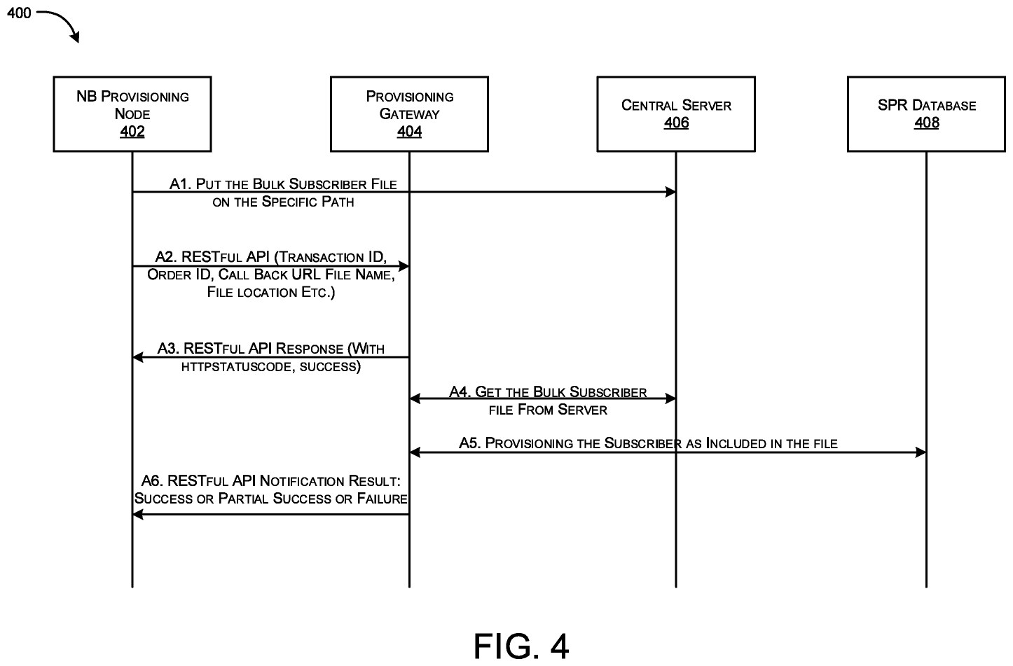

FIG. 4 illustrates an exemplary sequence diagram of a method 400 for provisioning requests, in accordance with embodiments of the present disclosure.

At step A1, an NB provisioning node 402 may put a bulk subscriber file at a central server 406. In an embodiment, the NB provisioning node 402 may put the subscriber file on a specific path at the central server 406. In an embodiment, the central server 406 may include, but not limited to, a File Transfer Protocol (FTP) server. A person skilled in the art will understand that FTP is a standard communication protocol used for the transfer of files from a server to a client on a network. The NB provisioning node 402 may be similar to NB provisioning node (204 of FIGS. 2A-2B, 302 of FIGS. 3A-3B) in functionality, and hence, may not be described in detail again for the sake of brevity.

At step A2, the NB provisioning node 402 may send a provisioning request over a RESTful API to a provisioning gateway 404. In an embodiment, the provisioning request may include, but not be limited to, a transaction identifier (ID), an order ID, uniform resource locator (URL) associated with a service selected by a user of a computing device (for example, 102 of FIG. 1), file name, file location, and the like. A person skilled in the art will understand that the provisioning gateway 404 may be similar to the provisioning gateway (108 of FIG. 1, 206 of FIGS. 2A-2B, 304-1, 304-2 of FIGS. 3A-3B) in functionality, and hence, may not be described in detail again for the sake of brevity.

At step A3, the provisioning gateway 404 may send a response over the RESTful API with an HTTP status code indicating that the provisioning request is received to the NB provisioning node 402. In an embodiment, the provisioning gateway 404 may send an asynchronous acknowledgement success response to the NB provisioning node 402.

Further, at step A4, the provisioning gateway 404 may get the bulk subscriber file from the central server 406. In an embodiment, the provisioning gateway 404 may get the bulk subscriber file based on the provision request received from the NB provisioning node 402, for example, details of the provisioning request.

At step A5, the provisioning gateway 404 may send the provisioning request to provision the subscriber/user as included in the bulk subscriber file to an SPR database 408. The database 408 may then provision the subscriber information as included in the file. A person skilled in the art will understand that the database 408 may be similar to the database (104 of FIG. 1, 208 of FIGS. 2A-2B, 308 of FIGS. 3A-3B) in functionality, and hence, may not be described in detail again for the sake of brevity. In an embodiment, the provisioning gateway 404 may receive a response from the database 408, for example, a success response, a partial success response, or a failure response.

At step A6, the provisioning gateway 404 may forward the response in form of notification result over the RESTful API to the NB provisioning node 402. In an embodiment, if the response is a failure response, the NB provisioning node 402 and/or the provisioning gateway 404 may perform error handling functionality, as explained in detail with reference to FIGS. 3A and 3B. For example, the NB provisioning node 402 may retry the provisioning request to another provisioning gateway on any redundant site, and/or the provisioning gateway 404 may retry the provisioning request to another database.

A person of ordinary skill in the art will readily ascertain that the illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments.

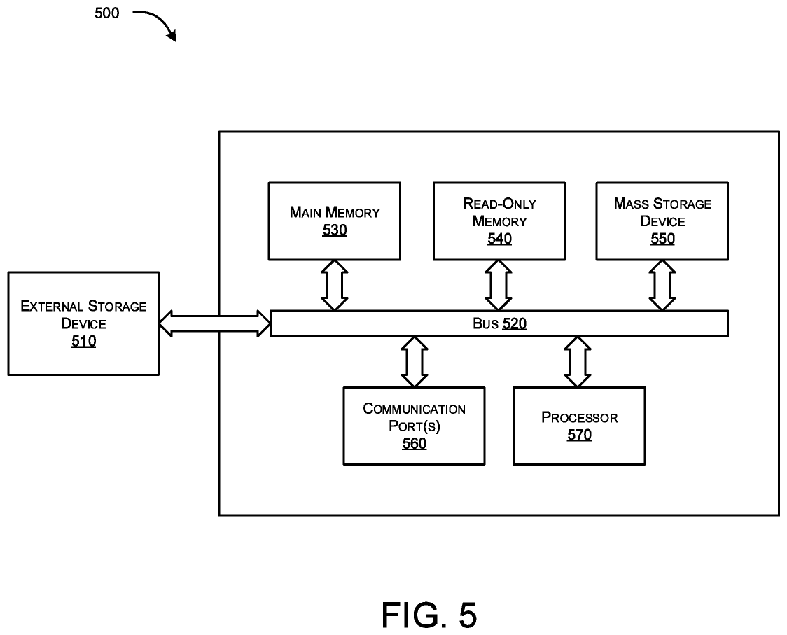

FIG. 5 illustrates an exemplary computer system 500 in which or with which embodiments of the present disclosure may be implemented. It may be appreciated that the provisioning system 108 may be implemented as the computer system 500.

As shown in FIG. 5, the computer system 500 may include an external storage device 510, a bus 520, a main memory 530, a read-only memory 540, a mass storage device 550, communication port(s) 560, and a processor 570. A person skilled in the art will appreciate that the computer system 500 may include more than one processor and communication port(s). The processor 570 may include various modules associated with embodiments of the present disclosure. The communication port(s) 560 may be any of an RS-232 port for use with a modem-based dialup connection, a 10/100 Ethernet port, a Gigabit or 10 Gigabit port using copper or fibre, a serial port, a parallel port, or other existing or future ports. The communication port(s) 660 may be chosen depending on a network, such a Local Area Network (LAN), Wide Area Network (WAN), or any network to which the computer system 500 connects. The main memory 530 may be random-access memory (RAM), or any other dynamic storage device commonly known in the art. The read-only memory 540 may be any static storage device(s). The mass storage device 550 may be any current or future mass storage solution, which can be used to store information and/or instructions.

The bus 520 communicatively couples the processor 570 with the other memory, storage, and communication blocks. Optionally, operator and administrative interfaces, e.g. a display, keyboard, and a cursor control device, may also be coupled to the bus 520 to support direct operator interaction with the computer system 500. Other operator and administrative interfaces may be provided through network connections connected through the communication port(s) 560. Components described above are meant only to exemplify various possibilities. In no way should the aforementioned exemplary computer system 500 limit the scope of the present disclosure.

While considerable emphasis has been placed herein on the preferred embodiments, it will be appreciated that many embodiments can be made and that many changes can be made in the preferred embodiments without departing from the principles of the invention. These and other changes in the preferred embodiments of the invention will be apparent to those skilled in the art from the disclosure herein, whereby it is to be distinctly understood that the foregoing descriptive matter to be implemented merely as illustrative of the invention and not as limitation.

### ADVANTAGES OF THE INVENTION

The present disclosure provides a provisioning gateway that has an ability to multicast single requests to different databases.

The present disclosure allows for faster database operations such as, but not limited to, create, modify, get, delete, and the like.

The present disclosure provides a provisioning gateway that reduces the chance of data loss/mismatch between databases by using error handling capability.

The present disclosure facilitates improving efficiency and flexibility by providing a provisioning gateway that may forward provisioning requests to multiple network domains.

The present disclosure provides a provisioning gateway application that is lightweight and does not take up huge hardware resources.

The present disclosure provides a robust provisioning infrastructure that improves customer experience and reduces customer churn.

We claim:

1. A provisioning system (108), comprising:
one or more processors; and
a memory operatively coupled with the one or more processors, wherein the memory comprises processor-executable instructions which, when executed, cause the one or more processors to:
receive a provisioning request corresponding to a computing device (102) via a provisioning node (204);
determine one or more databases (208) associated with the computing device (102) based on the received provisioning request;
multicast the provisioning request to provision a user associated with the computing device (102) to the determined one or more databases (208);
receive a response from the one or more databases (208) based on provisioning identified in the provisioning request; and
transmit the response to the provisioning node (204).

2. The provisioning system (108) as claimed in claim 1, wherein the one or more processors are to multicast the provisioning request to the one or more databases (208) via an intermediary node.

3. The provisioning system (108) as claimed in claim 1, wherein the response comprises one of: a success response, a partial success response, and a failure response.

4. The provisioning system (108) as claimed in claim 3, wherein in case of the failure response, the one or more processors are to retransmit the provisioning request to at least one of:
another provisioning system on a redundant site via the provisioning node (204); and
another database of the one or more databases (208).

5. The provisioning system (108) as claimed in claim 2, wherein the one or more processors are to:
receive an error notification from the intermediary node;
determine if the error notification corresponds to a pre-defined error list;
in response to the error notification corresponding to the pre-defined error list, retransmit the provisioning request to the one or more databases (208) through another intermediary node;
in response to the error notification not corresponding to the pre-defined error list, redirect the error notification to the provisioning node (204).

6. The provisioning system (108) as claimed in claim 1, wherein the provisioning request comprises at least one of: a transaction identifier (ID), an order ID, uniform resource locator (URL) associated with a service selected by the user of the computing device (102), file name, and file location.

7. The provisioning system (108) as claimed in claim 1, wherein the one or more processors are to multicast the provisioning request to the one or more databases (208) over a RESTful interface.

8. The provisioning system (108) as claimed in claim 1, wherein the one or more databases (208) comprise information about the user associated with the computing device (102) served by a particular network domain (106).

9. The provisioning system (108) as claimed in claim 8, wherein the network domain (106) comprises at least one of: 4G network domain, and 5G network domain.

10. The provisioning system (108) as claimed in claim 9, wherein the one or more databases (208) comprise at least one of: 4G mobility database (208-1), 4G Internet of Things (IoT) database (208-2), 5G mobility database (208-3), and 5G IoT database (208-4).

11. A method for provisioning requests, comprising:
receiving, by a provisioning system (108), a provisioning request corresponding to a computing device (102) via a provisioning node (204);
determining, by the provisioning system (108), one or more databases (208) associated with the computing device (102) based on the received provisioning request;
multicasting, by the provisioning system (108), the provisioning request to provision a user associated with the computing device (102) to the determined one or more databases (208);
receiving, by the provisioning system (108), a response from the one or more databases (208) based on provisioning identified in the provisioning request; and
transmitting, by the provisioning system (108), the response to the provisioning node (204).

12. The method as claimed in claim 11, wherein the multicasting comprises multicasting, by the provisioning system (108), the provisioning request to the one or more databases (208) via an intermediary node.

13. The method as claimed in claim 11, wherein the response comprises one of: a success response, a partial success response, and a failure response.

14. The method as claimed in claim 13, wherein in case of the failure response, the method comprises retransmitting, by the provisioning system (108), the provisioning request to at least one of:
another provisioning system on a redundant site via the provisioning node (204); and
another database of the one or more databases (208).

15. The method as claimed in claim 12, comprising:
receiving, by the provisioning system (108), an error notification from the intermediary node;
determining, by the provisioning system (108), if the error notification corresponds to a pre-defined error list;
in response to the error notification corresponding to the pre-defined error list, retransmitting, by the provisioning system (108), the provisioning request to the one or more databases (208) through another intermediary node; and
in response to the error notification not corresponding to the pre-defined error list, redirecting, by the provisioning system (108), the error notification to the provisioning node (204).

16. A non-transitory computer-readable medium comprising processor-executable instructions that cause a processor to:
receive a provisioning request corresponding to a computing device (102) via a provisioning node (204);
determine one or more databases (208) associated with the computing device (102) based on the received provisioning request;
multicast the provisioning request to provision a user associated with the computing device (102) to the determined one or more databases (208);
receive a response from the one or more databases (208) based on provisioning identified in the provisioning request; and
transmit the response to the provisioning node (204).
